(19) United States
(12) Patent Application Publication
(10) Pub. No.: US 2013/0184408 A1
(43) Pub. Date: Jul. 18, 2013

(54) USE OF LOW MOLECULAR WEIGHT POLYTRIMETHYLENE ETHER GLYCOL AS A POLYMERIZATION SOLVENT

(71) Applicant: E I DU PONT DE NEMOURS AND COMPANY, Wilmington, DE (US)

(72) Inventors: Hari Babu Sunkara, Hockessin, DE (US); Sheau-Hwa Ma, West Chester, PA (US); Rajesh Gopalan Saliya, Philadelphia, PA (US); Ayumu Yokoyama, Wallingford, PA (US)

(73) Assignee: E I DU PONT DE NEMOURS AND COMPANY, Wilmington, DE (US)

(21) Appl. No.: 13/735,087

(22) Filed: Jan. 7, 2013

Related U.S. Application Data
(60) Provisional application No. 61/587,226, filed on Jan. 17, 2012.

(51) Int. Cl. C08K 5/06

(52) U.S. Cl. CPC C08K 5/06
USPC 524/762

(57) ABSTRACT

The present disclosure relates to a process of forming a polymer composition by the free radical polymerization of a monomer mixture in the presence of low molecular weight polytrimethylene ether glycol. The polytrimethylene ether glycol has a number average molecular weight in the range of from 120 to 490. The polymer composition can be used to form a coating composition that has a low volatile organic solvent content.

### CROSS-REFERENCE TO RELATED APPLICATION

This application claims priority under 35 U.S.C. §119 from U.S. Provisional Application Ser. No. 61/587,226, filed Jan. 17, 2012, which is hereby incorporated by referenced in its entirety.

### FIELD OF THE DISCLOSURE

The present disclosure is directed to the use of polytrimethylene ether glycol as a solvent for the free radical polymerization of a monomer mixture. The formation of a polymer, especially an acrylic polymer, can result in a polymer composition that has a very low volatile organic content (VOC). Such a polymer composition can have use in a number of applications including, for example, coating compositions.

### BACKGROUND OF DISCLOSURE

Coating compositions, especially compositions for use in the automotive manufacturing and repair industries, constitute a large market. Many of these coating compositions use large amounts of organic solvent which can escape during the curing process as volatile organic solvent. Organic solvents are present in virtually every step of the process, beginning with the initial formation of the polymers from the polymerization of a monomer mixture. The free radical polymerization of monomers generally requires that a monomer mixture is dissolved, suspended or otherwise dispersed in an organic solvent. After the polymerization process, the remaining organic solvent can be retained and in a subsequently formed coating composition, can add to the volatile organic content of the composition. In some cases, the organic solvent can be reduced by distillation or other known methods. This can result in a coating composition having not only a lower volatile organic content, but also a higher viscosity which can negatively impact certain properties of the coating composition such as, for example, the sprayability and the appearance of the applied coating composition.

There is a continuing need to produce polymer compositions having a lower volatile organic content and coating compositions containing those polymers.

### STATEMENT OF THE DISCLOSURE

The present disclosure is directed to a process for producing a polymer having a low volatile organic content. The process comprises the steps:

1) forming a polymerizable mixture comprising:
a) a monomer mixture,
b) polytrimethylene ether glycol having a number average molecular weight in the range of from 120 to 490, and
c) a free radical polymerization initiator;

2) polymerizing the monomer mixture to form a composition comprising a polymer and polytrimethylene ether glycol.

The present disclosure further relates to a polymer composition comprising a polymer formed by the process outline in the paragraph above wherein the polytrimethylene ether glycol has a number average molecular weight in the range of from 120 to 490. In another embodiment, the present disclosure also relates to a coating composition comprising the polymer composition.

### DETAILED DESCRIPTION

The features and advantages of the present disclosure will be more readily understood, by those of ordinary skill in the art, from reading the following detailed description. It is to be appreciated that certain features of the disclosure, which are, for clarity, described above and below in the context of separate embodiments, may also be provided in combination in a single embodiment. Conversely, various features of the disclosure that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about”. In this manner, slight variations above and below the stated ranges can be used to achieve substantially the same results as values within the ranges. Also, the disclosure of these ranges is intended as a continuous range including every value between the minimum and maximum values.

As used herein:

The term “(meth)acrylate” means methacrylate or acrylate.

The term “two-pack coating composition”, also known as 2K coating composition, refers to a coating composition having two packages that are stored in separate containers and sealed to increase the shelf life of the coating composition during storage. The two packages are mixed just prior to use to form a pot mix, which has a limited pot life, typically ranging from a few minutes (15 minutes to 45 minutes) to a few hours (4 hours to 8 hours). The pot mix is then applied as a layer of a desired thickness on a substrate surface, such as an automobile body. After application, the layer dries and cures at ambient or at elevated temperatures to form a coating on the substrate surface having desired coating properties, such as, high gloss, mar-resistance and resistance to environmental etching.

The term “one-pack coating composition”, also known as 1K coating composition, refers to a coating composition having one package that are stored in one container and sealed to increase the shelf life of the coating composition during storage. The 1K coating composition can be formulated to be cured at certain curing conditions. Examples of such curing conditions can include: radiation, such as UV radiation including UV-A, UV-B, and UV-C radiations, electron beam (e-beam) radiation, or lights in visible wavelengths; moisture, such as water accessible to the coating composition; heat energy, such as high temperatures; or other chemical or physical conditions.

The process for formation of a polymer can comprise or consist essentially of the steps of:

1) forming a polymerization mixture comprising or consisting of;
a) a monomer mixture,
b) a solvent comprising polytrimethylene ether glycol having a number average molecular weight in the range of from 130 to 660 and;
c) a free radical polymerization initiator; and;

2) polymerizing the monomer mixture.

The monomer mixture can be one type of monomer or a mixture of two or more different monomers. In some embodiments, the monomer mixture comprises or consists of monomers having ethylenically unsaturated double bonds. A variety of monomers having ethylenically unsaturated double bonds are known in the art and can be used. (Meth)acrylate, vinyl and styrenic compounds are examples of monomers that can be used in the monomer mixture.

In some embodiments, the monomer mixture is a mixture including at least two different monomers. The process can be applied to the preparation of copolymers from mixtures of two or more monomers. In some embodiments, mixtures of at least one (meth)acrylic monomer and at least one non-(meth)acrylic monomer such as a styrenic monomer may be polymerized in accordance with the present process.

The (meth)acrylate monomers as employed herein include acrylic or methacrylic acid, esters of acrylic or (meth)acrylic acid and derivatives and mixtures thereof, such as, for example, alkyl (meth)acrylates that have 1-18 carbon atoms in the alkyl group such as methyl (meth)acrylate, ethyl (meth)acrylate, propyl (meth)acrylate, n-butyl (meth)acrylate, isopropyl (meth)acrylate, isobutyl (meth)acrylate, t-butyl (meth)acrylate, amyl (meth)acrylate, hexyl (meth)acrylate, isoamyl (meth)acrylate, 2-ethylhexyl (meth)acrylate, nonyl (meth)acrylate, lauryl (meth)acrylate and stearyl (meth)acrylate. Cycloaliphatic (meth)acrylates can also be used, for example, trimethylcyclohexyl (meth)acrylate, t-butylcyclohexyl (meth)acrylate, cyclohexyl (meth)acrylate and isobornyl (meth)acrylate. Aryl (meth)acrylates can also be used, for example, benzyl (meth)acrylate and phenyl (meth)acrylate.

Other suitable (meth)acrylic monomers can include, for example, (meth)acrylic acid derivatives such as: (meth)acrylic acid and its salts, (meth)acrylonitrile, (meth)acrylamide, N-alkyl (meth)acrylamide, N, N-dialkyl (meth)acrylamide, N-phenyl-(meth)acrylamide and (meth)acrolein.

Apart from (meth)acrylic monomers, other polymerizable non-(meth)acrylic monomers that can be used for forming the monomer mixture and can include, for example, vinyl aromatics such as styrene, alpha-methyl styrene, t-butyl styrene, vinyl toluene; vinyl acetate, and vinyltrimethoxy silane.

Functionalized versions of any of the monomers listed above may be used in the preparation of the polymer to impart crosslinkable functionality to the polymer. The functional groups on such monomers should be capable of crosslinking with themselves or with other film-forming polymers. Typically crosslinking functional groups include hydroxyl, epoxide, carboxyl, anhydride, carbamate, and amine groups. Combinations of monomers containing the above mentioned crosslinking functional groups are also suitable, provided that they do not react with each other under polymerization and/or storage conditions.

Typical ethylenically unsaturated monomers that can be used to introduce crosslinking functional groups into the polymer during its polymerization include, for example, epoxy functional acrylic monomers such as glycidyl (meth)acrylate; carboxyl or other acid functional monomers such as (meth)acrylic acid, maleic acid, itaconic acid, styrene sulfonic acid, acrylamido methyl propane sulfonic acid, vinyl phosphonic or vinyl phosphoric acid; hydroxyl functional acrylic monomers such as hydroxyethyl (meth)acrylate, hydroxypropyl (meth)acrylate, 2-hydroxypropyl (meth)acrylate, 3-hydroxypropyl (meth)acrylate, hydroxybutyl (meth)acrylate; amine functional monomers such as t-butyl amino ethyl (meth)acrylate, dimethyl amino ethyl (meth)acrylate, aminoalkyl (meth)acrylates; carbamate functional (meth)acrylic monomers such as 2-(methoxycarbonyl) aminoethyl (meth)acrylate, 2-(cyclohexoxycarbonyl) aminoethyl (meth)acrylate and 2-propenyloxyethyl carbamate. Combinations of any of the aforementioned monomers can also be used, however, functional groups that react with one another should be avoided.

The polymerizable mixture further comprises or consists of b) polytrimethylene ether glycol, wherein the polytrimethylene ether glycol has a number average molecular weight in the range of from 120 to 490. This molecular weight range equates to a polytrimethylene ether glycol having in the range of from 2 to 11 repeat units. In other embodiments, the number average molecular weight can be in the range of from 130 to 475, and in other embodiments, the number average molecular weight can be in the range of from 150 to 450, and, in still further embodiments, the number average molecular weight can be in the range of from 175 to 400. The units of the number average molecular weight are given in grams per mole. Polymers formed via this polymerization process can be used directly in a coating composition with no further distillation or purification steps. The polymer composition comprising the polymer and the polytrimethylene ether glycol can be used to form a coating composition that has a volatile organic content in the range of from 360 grams/liter (3.0 lbs/gallon) to 0 grams/liter. One method for determining the volatile organic content of a coating composition is ASTM D3960.

In some embodiments, in can be useful to add an organic solvent to the polymerizable mixture. In some embodiments, the organic solvent can be a volatile organic content (VOC) exempt solvent. Suitable VOC exempt solvents are known and a list of such solvents can be found in the Code of Federal Regulations at 40 CFR 51.100. If a mixture of polytrimethylene ether glycol and an organic solvent is used, the polytrimethylene ether glycol can be present in the range of from 1 percent to 99 percent by weight, based on the total amount of the solvent. In other embodiments, the polytrimethylene ether glycol can be present in the range of from 2 percent to 75 percent by weight, based on the total amount of the solvent. In other embodiments, the amount of polytrimethylene ether glycol can be in the range of from 3 percent by weight to 50 percent by weight, and, in still further embodiments, the amount of polytrimethylene ether glycol can be in the range of from 5 percent to 35 percent by weight, wherein the percentage by weight are based on the total amount of the solvent.

As was stated above, the organic solvent can be a volatile organic content exempt solvent. However, it can also be an organic solvent that is not a volatile organic content exempt solvent. Suitable organic solvents can include, for example, aromatic hydrocarbons, such as petroleum naphtha or xylenes; ketones, such as, methyl amyl ketone, methyl isobutyl ketone, methyl ethyl ketone or acetone; esters, such as, butyl acetate or hexyl acetate; glycol ether esters, such as propylene glycol monomethyl ether acetate; or a combination thereof.

The polytrimethylene ether glycol can be prepared by an acid-catalyzed polycondensation of 1,3-propanediol, such as described in U.S. Pat. Nos. 6,977,291 and 6,720,459. The polytrimethylene ether glycol can also be prepared by a ring opening polymerization of a cyclic ether, oxetane, such as described in J. Polymer Sci., Polymer Chemistry Ed. 28, 449 to 444 (1985). The polycondensation of 1,3-propanediol is preferred over the use of oxetane since the diol is a less hazardous, stable, low cost, commercially available material and can be prepared by use of petro chemical feed-stocks or renewable resources.

A bio-route via fermentation of a renewable resource can be used to obtain the 1,3-propanediol. One example of a renewable resource is corn as it is readily available and has a high rate of conversion to 1,3-propanediol and can be genetically modified to improve yields to the 1,3-propanediol. Examples of typical bio-route can include those described in U.S. Pat. No. 5,686,276, U.S. Pat. No. 5,633,362 and U.S. Pat. No. 5,821,092. The 1,3-propanediol obtained from the renewable source can be distinguished from their petrochemical derived counterparts on the basis of radiocarbon dating such as fraction of modern carbon (f_{M}), also know as carbon-14 (f_{M}) and dual carbon-isotopic fingerprinting carbon-13/carbon-12 such the one known as δ13C. The fraction of modern carbon f_{M} is defined by National Institute of Standards and Technology (NIST) Standard Reference Materials (RFMs) 4990B and 4990C. 1,3-propane diol produced via a bio-route is known as bio-1,3-popane diol. When bio-1,3-propane diol is used to make polytrimethylene ether glycol, the resulting polyether is known as bio-polytrimethylene ether glycol. In some embodiments, the polymerizable mixture comprises bio-polytrimethylene ether glycol having the previously mentioned number average molecular weight ranges. Bio-polytrimethylene ether glycol can be distinguished from polytrimethylene ether glycols produced from petroleum feedstocks using the same radiocarbon dating methods.

The polytrimethylene ether glycol can be fractionated or unfractionated. By fractionated is meant that the that the polycondensation product of 1,3-propane diol is distilled or otherwise purified so that the polytrimethylene ether glycol product has a polydispersity in the range of from 1 to 3. By unfractionated is meant that the product used to prepare the polytrimethylene ether glycol is used as is and that the unfractionated polytrimethylene ether glycol product has a polydispersity of greater than 3. As is well known to those of ordinary skill in the art, polydispersity is a ratio of the weight average molecular weight divided by the number average molecular weight.

Copolymers of polytrimethylene ether glycol also can be suitable. Examples of suitable copolymers of polytrimethylene ether glycol can be prepared by copolymerizing 1,3-propanediol with another diol, such as, ethane diol, hexane diol, 2-methyl-1,3-propanediol, 2,2-dimethyl-1,3-propanediol, trimethylol propane and pentaerythritol. In some embodiments, the copolymers of polytrimethylene ether glycol can have a 1,3-propanediol content in a range of from 50 percent by weight to 99 percent by weight, based on the total weight of the monomers used to form the polytrimethylene ether glycol copolymer. In other embodiments, the copolymers of polytrimethylene ether glycol can have a 1,3-propanediol content in a range of from 60 percent by weight to 99 percent by weight, based on the total amount of the monomers used to form the polytrimethylene ether glycol copolymer. In still further embodiments, the copolymers of polytrimethylene ether glycol can have a 1,3-propanediol content in a range of from 70 percent by weight to 99 percent by weight, based on the total amount of the monomers used to form the polytrimethylene ether glycol copolymer.

The polymerizable mixture can further comprise or consist of c) a polymerization initiator. Suitable polymerizations initiators can include, for example, azo and peroxide type initiators, t-butyl peroxide, t-butyl peroxybenzoate, t-butyl peroctoate, cumene hydroperoxide, 2,2′-azobis(isobutyronitrile) (VAZO® 64 thermal initiator available from DuPont, Wilmington, Del.); 4,4′-azobis(4-cyanovaleric acid) (VAZO® 52 thermal initiator available from DuPont, Wilmington, Del.) and 2-(t-butylazo)-2-cyanopropane, benzoyl peroxide, or a combination thereof. It is preferred to add from about 0.1 to about 8.0 percent by weight of the polymerization initiator, based on the total weight of the monomer mixture.

The polymers produced by this process include (meth)acrylic polymers and copolymers, styrenated (meth)acrylic copolymers, styrene polymers and copolymers, and vinyl acetate polymers and copolymers or combinations thereof. Dispersed gelled (meth)acrylic polymers and copolymers can also be made using this process. Dispersed gelled (meth)acrylic polymers are commonly referred to as non-aqueous dispersed polymers or NAD polymers. One method of preparing NAD polymers is to form a macromonomer that acts as a polymeric stabilizer component when it is subsequently chemically grafted to a crosslinked core. The linear stabilizer components are soluble in the organic liquid used to form the NAD while the core is insoluble in this liquid.

The process for formation of a polymer comprises the steps of;

1) forming a polymerizable mixture comprising
a) a monomer mixture,
b) polytrimethylene ether glycol having a number average molecular weight in the range of from 130 to 660, and
c) a free radical polymerization initiator;

2) polymerizing the monomer mixture to form a composition comprising a polymer and polytrimethylene ether glycol.

The step of polymerizing the monomer mixture can be performed at a temperature in the range of from 20° C. to 200° C. Various types of addition polymerizations can be carried out using the disclosed process, such as free radical, anionic, group transfer and atom transfer radical polymerization reactions. Free radical polymerization reactions are generally preferred. The reaction is also typically carried out under atmospheric pressure.

In some embodiments, the step of forming the polymerizable mixture can occur in several ways. In some embodiments, a reaction vessel can be charged with the polytrimethylene ether glycol and/or the organic solvent, which can be heated to an elevated temperature, if desired. Separately, the monomer mixture can be formed in polytrimethylene ether glycol and/or organic solvent and added to a addition funnel. A mixture of the polymerization initiator in polytrimethylene ether glycol and/or organic solvent can be added to a second addition funnel. The monomer mixture and the polymerization initiator mixtures can be added over a given time period to the reaction vessel. The time period for the addition of the monomer mixture and the polymerization initiator can be identical, or the initiator can be added over a longer time period than that of the monomer mixture. The contents of the reaction vessel can be held at an elevated temperature until the polymer forms. The time period for the addition of the monomer mixture and the initiator mixture can independently be in the range of from less than one minute to up to 24 hours.

In other embodiments, the monomer mixture can be added to a reaction vessel in the polytrimethylene ether glycol and/or organic solvent. This mixture can be heated to an elevated temperature, if desired. Separately, a mixture of the initiator and polytrimethylene ether glycol and/or organic solvent can be formed and added to a dropping funnel. The initiator mixture can be added to the reaction vessel over a given time period. After the initiator mixture is added, the contents of the reaction vessel can be held at an elevated temperature until the polymer forms. The time period for the addition of the initiator mixture can be in the range of from less than one minute to up to 24 hours.

The current disclosure further relates to a polymer composition produced using the disclosed process. The polymer composition comprises or consists essentially of the polymer produced by the polymerization of the monomer mixture and solvent including the polytrimethylene ether glycol. The polymer composition may contain small amounts (generally less than 5 percent by weight, based on the total amount of the polymerizable mixture) of dissociated initiator and unpolymerized monomers, but otherwise, consists of the polymer and solvent. The composition may include any additional organic solvent that may have been added to form the polymerization mixture. As one of ordinary skill in the art would understand, any residue of the initiator may also be present in the polymer composition.

The polymer composition can be useful for producing a coating composition, a cosmetic product, an ink for an inkjet printer, a dispersing agent for pigments or other solid particles or a rheology control agent. In some embodiments, the present disclosure relates to a coating composition comprising the polymer composition formed via the disclosed process. In addition to the polymer compositions, the coating composition, can further include at least one of a crosslinking agent, pigments, rheology control agent, light stabilizer, crosslinking catalyst or a combination thereof. In some embodiments, the crosslinking agent can be a polyisocyanate crosslinking agent.

Coating compositions comprising the polymer composition can be used as a primer compositions, a basecoat composition, or a clearcoat composition. It has been found that the use of the disclosed polymer composition can form a coating composition that has a faster dry-to-touch time than does a coating composition that does not contain the polymer composition in polytrimethylene ether glycol. Layers of cured and dried coating compositions formed using the disclosed polymer composition also have higher 60 degree gloss than does a coating composition that does not contain the polymer composition in polytrimethylene ether glycol.

### EXAMPLES

Unless otherwise specified, all ingredients are available from the Aldrich Chemical Company, Milwaukee, Wis.

VAZO® 67 initiator and CERENOL® H250 polytrimethylene ether glycol are both available from DuPont, Wilmington, Del.

Preparation of Acrylic Polymers 1-4

TABLE 1

| | | | |
|---|---|---|---|
| Acrylic | Acrylic | Acrylic | Acrylic |
| Polymer 1 | Polymer 2 | Polymer 3 | Polymer 4 |

Portion 1

| | | | | |
|---|---|---|---|---|
| CERENOL ® H250 | 40.7 | 135.5 | 67.7 | 271.0 |
| t-butyl acetate | 230.3 | 135.5 | 203.3 | 0 |

Portion 2

| | | | | |
|---|---|---|---|---|
| t-butyl acetate | 25 | 25 | 25 | 25 |
| methyl methacrylate | 307.4 | 307.4 | 307.4 | 307.4 |
| styrene | 123 | 123 | 123 | 123 |
| 2-hydroxyethyl | 245.9 | 245.9 | 245.9 | 245.9 |
| methacrylate | | | | |
| n-butyl acrylate | 307.4 | 307.4 | 307.4 | 307.4 |
| 2-ethylhexyl | 245.9 | 245.9 | 245.9 | 245.9 |
| methacrylate | | | | |

Portion 3

| | | | | |
|---|---|---|---|---|
| VAZO ® 67 | 70.8 | 70.8 | 70.8 | 70.8 |
| t-butyl acetate | 461.3 | 461.3 | 461.3 | 461.3 |

Portion 4 (rinse for Portion 2)

| | | | | |
|---|---|---|---|---|
| t-butyl acetate | 16.5 | 16.5 | 16.5 | 16.5 |

Portion 5 (rinse for Portion 3)

| | | | | |
|---|---|---|---|---|
| t-butyl acetate | 25.8 | 25.8 | 25.8 | 25.8 |
| temperature during | 100° C.-106° C. | 102° C.-108° C. | 100° C.-113° C. | 102-116° C. |
| addition | | | | |
| CERENOL ®, percent of | 5.1 | 17.9 | 26.8 | 35.8 |
| total solvent | | | | |
| Weight percent solids | 61.4 | 63.5 | 67.0 | 69.2 |
| Gardner-Holdt viscosity | Y + ½ | Z + ¼ | Z2 | Z3 + ½ |
| Mₙ | 3606 | 2620 | 2579 | 2044 |
| M_{w} | 9154 | 9262 | 10376 | 9704 |

The ingredients of portion 1 were added to a reaction vessel equipped with a stirrer, two dropping funnels, a thermometer and a nitrogen inlet. Portion 1 was heated to reflux. The ingredients of portion 2 were mixed and added to one of the dropping funnels. The ingredients of portion 3 were added to the other dropping funnel. Portion 2 was added to the reaction vessel over a 390 minute period. Portion 3 was added to the reaction vessel, simultaneously with portion 2 but over a 400 minute period. Portion 4 was used as a line rinse for Portion 2 and Portion 5 was used as a line rinse for Portion 3. When the additions were complete, the reaction mixture was held for 60 minutes at reflux, then cooled to room temperature.

Preparation of Acrylic Polymer 5

13.7 parts by weight of t-butyl acetate was charged to a reaction vessel equipped with a stirrer, two addition funnels, reflux condenser and a nitrogen inlet. The solvent was heated to reflux. A premade mixture of 8.8 parts by weight of methyl methacrylate, 5.9 parts styrene, 11.7 parts hydroxyethyl methacrylate, 20.5 parts n-butyl acrylate, 11.7 parts of 2-ethyl hexyl methacrylate and 1.2 parts of t-butyl acetate was added to the first addition funnel. A premade mixture of 3.4 parts by weight of VAZO® 67 initiator (available from DuPont, Wilmington, Del.) and 23.2 parts of t-butyl acetate was added to the second addition funnel. The monomer mixture was fed to the reactor over a 390 minute period. Concurrently, the initiator mixture was added to the reactor over a 400 minute period. After the additions were complete, the reaction mixture was maintained at reflux for an additional 30 minutes. The reaction was cooled to room temperature and the product was used as is.

Preparation of Pigment Dispersion

TABLE 2

| Ingredient | Wt (grams) |
|---|---|
| t-butyl acetate | 72.7 |
| EFKA ®-4340 dispersant⁽¹⁾ | 35.4 |
| Magnesium montmorillonite⁽²⁾ | 2.3 |
| Acrylic polymer 5 | 211.6 |
| Total | 321.8 |

⁽¹⁾Available from Ciba Specialty Chemicals Inc, Tarrytown, New York, USA, under respective registered trademarks.
⁽²⁾Available as BENTONE ® 27 from Elementis Specialties Inc., Hightstown, New Jersey, USA, under respective registered trademarks.

A pigment dispersion was prepared using the following procedure.

The ingredients in Table 2 were added in order to an attritor with mixing and mixed for approximately 5 minutes. The quinacridone red pigment (CINQUASIA® red YRT-859-D by Ciba Specialty Chemicals) (How much?, this ingredient is not listed in the table) was slowly added and the mixture was mixed for another 5 minutes. The grinding media containing 1816 grams of ⅛″ steel shots, was added. The mixture was milled for 5 hours at 350 rpm. The dispersion was separated from the grinding media. The pigment was well dispersed to give a uniform dispersion with a viscosity of 770 cps at 20 rpm as measured by a Brookfield viscometer.

Preparation of Coating Compositions

TABLE 3

| | Comparative | | Comparative | |
|---|---|---|---|---|
| | Coating | Coating | Coating | Coating |
| | Composition | Composition | Composition | Composition |
| | A | 1 | B | 2 |
| Acrylic | — | 62 | — | 84.6 |
| polymer #1 | | | | |
| Acrylic | 65.6 | — | 86.5 | — |
| polymer⁽¹⁾ | | | | |
| Pigment | 22.9 | 22.5 | — | — |
| Dispersion | | | | |
| FG-1333 | 11.5 | 15.5 | 13.5 | 15.4 |
| crosslinking | | | | |
| agent⁽²⁾ | | | | |
| Total | 100 | 100 | 100 | 100 |
| NCO/OH | 0.95 | 0.97 | 0.96 | 0.98 |

Results

| | | | | |
|---|---|---|---|---|
| Dry to touch | 4 | 3 | 5 | 4 |
| [hr] | | | | |
| Gloss at 60 | 88 | 90 | 90 | 95 |
| degrees | | | | |

⁽¹⁾JONACRYL ® 918 available from BASF Resins, Wyandotte, Wisconsin, is an acrylic polymer with a Tg of 36° C.
⁽²⁾FG-1333 polyisocyanate is available from DuPont, Wilmington, Delaware.

The comparative coating compositions A and B and the coating compositions 1 and 2 were prepared by mixing together the ingredients of TABLE 3 in a suitable mixing vessel. The prepared coating compositions were applied to a substrate (what is the substrate?) using a (spray gun?). After application, the applied layers of coating compositions were flash dried at room temperature for X minutes and then (baked?/air dried?) for X hours.

What is claimed is:

1. A process for the formation of a polymer comprising the steps of;
1) forming a polymerizable mixture comprising:
a) a monomer mixture,
b) a solvent comprising polytrimethylene ether glycol having a number average molecular weight in the range of from 130 to 660 and;
c) a free radical polymerization initiator;
2) polymerizing the monomer mixture to form a composition comprising a polymer and polytrimethylene ether glycol.

2. The process of claim 1 wherein the polymerization step occurs at a temperature in the range of from 20° C. to 200° C., wherein the temperature is the temperature of the polymerizable mixture.

3. The process of claim 1 wherein the monomer mixture comprises one or more (meth)acrylic monomers.

4. The process of claim 3 wherein the (meth)acrylic monomers are alkyl (meth)acrylates, hydroxyalkyl (meth)acrylates, (meth)acrylamide, N-alkyl (meth)acrylamides, N,N-dialkyl (meth)acrylamide, aminoalkyl (meth)acrylate, N-aminoalkyl (meth)acrylate, N,N-dialkylamino (meth)acrylate, epoxy functional alkyl (meth)acrylate, silane functional alkyl (meth)acrylates or a combination thereof; and wherein each alkyl group can be the same or different and contain in the range of from 2 to 10 carbon atoms.

5. The process of claim 3 wherein the monomer mixture further comprises styrene, acrylonitrile, methacrylonitrile, vinyl alkyl esters, vinyl ethers or a combination thereof.

6. The process of claim 1 wherein the polymerization mixture further comprises organic solvent.

7. The process of claim 6 wherein the organic solvent is t-butyl acetate.

8. The process of claim 1 wherein the polytrimethylene ether glycol is bio-polytriemthylene ether glycol.

9. The process of claim 6 wherein the polytrimethylene ether glycol can be present in the range of from 1 percent by weight to 99 percent by weight, based on the total amount of the polytrimethylene ether glycol and the organic solvent.

10. A polymer composition comprising a polymer produced by the steps of:
1) forming a polymerizable mixture comprising
a) a monomer mixture,
b) polytrimethylene ether glycol having a number average molecular weight in the range of from 130 to 660, and
c) a free radical polymerization initiator;
2) polymerizing the monomer mixture to form a composition comprising a polymer and polytrimethylene ether glycol.

11. A coating composition comprising the polymer composition of claim 10.

12. The coating composition of claim 11 further comprising at least one of a crosslinking component, pigment, rheology control agent, light stabilizer, crosslinking catalyst, or a combination thereof.

13. The coating composition of claim 12 wherein the crosslinking component is a polyisocyanate crosslinking agent.

14. The coating composition of claim 11 wherein the coating composition is a primer, a basecoat composition, or a clearcoat composition.

15. The coating composition of claim 11 wherein the coating composition has a volatile organic content of 360 grams/liter or less as determined by ASTM D3960.
